(19) United States
(12) Patent Application Publication
(10) Pub. No.: US 2021/0001595 A1
(43) Pub. Date: Jan. 7, 2021

(54) Acoustic Absorption Device

(71) Applicant: TEXAA, Gradignan (FR)

(72) Inventors: Fabrice LALANNE, Bordeaux (FR); Arnaud CALVET, Gradignan (FR); Guillaume MARTIN, Rochetoirin (FR)

(21) Appl. No.: 16/919,320

(22) Filed: Jul. 2, 2020

(30) Foreign Application Priority Data
Jul. 4, 2019 (FR) 1907484

(51) Int. Cl. B32B 5/26; B32B 27/36; G10K 11/162; B32B 27/12

(52) U.S. Cl. CPC B32B 5/26; B32B 27/36; G10K 11/162; B32B 2307/73; B32B 2307/732; B32B 2307/3065; B32B 2307/102; B32B 27/12

(57) ABSTRACT

An acoustic absorption and concealing device including at least one vertical strip including at least three structural layers, a central layer made of an acoustic absorbent material, and two external layers made of a knitted transonic material, applied on either side of the central layer, where the two external layers are made from flame-retardant polyester fibre threads and the central layer is made from polyester. The acoustic absorption and concealing device makes it possible to obtain a blind, or a partition panel of reduced thickness less than 7 mm having a low reaction to fire and optimal features of acoustic absorption, concealing and thermal reflections.

### CROSS-REFERENCE TO RELATED APPLICATION

This application claims priority to and the benefit of French Application No. FR 1907484 filed on 4 Jul. 2019, the disclosure of which is incorporated herein by reference in its entirety.

### BACKGROUND

### 1. Field

The present disclosure relates to acoustic absorption and concealing devices including vertical strips or vertical panels made of an absorbent material in an acoustic plane such as a blind or a partition panel. More specifically, the disclosure relates to an acoustic absorption and concealing device of reduced thickness having a low reaction to fire and optimal acoustic absorption and concealing features.

### 2. Brief Description of Related Developments

It is known from the prior art to use vertical blinds to dim the light from external openings such as a window, or to create modulable separations of space when the blind, or a partition panel is placed in the middle of a room. Using blinds including acoustic properties furthermore makes it possible to correct the internal acoustics of a room by reducing the reverberation. These blinds are particularly useful for correcting the acoustics of rooms with an increased level of reverberation like multifunctional rooms, conference rooms, restaurants, offices shared over an open space, meeting rooms, classrooms, etc.

European patent no. EP 0045711 describes, for example, a blind with vertical strips wherein each strip is formed of a sandwich, a central layer of the sandwich corresponding to an absorbent material such as an open cell foam or a highly aerated material like a fleece or a cotton. Two external layers cover each side of the central layer, these external layers are made of an aerated fabric making it possible to transmit soundwaves to the absorbent central layer and to cover it aesthetically. The preferred material for the absorbent layer is a polyurethane foam, a material widely used for its thermal insulation and acoustic absorption properties.

However, a polyurethane foam absorbent layer requires a thickness of about 10 mm to have a satisfactory absorption coefficient, a thickness which has disadvantages from a standpoint relating to the aesthetics and the flexibility of the strips of the blind. In addition, polyurethane has an unfavourable ecological footprint in view of its production which uses a lot of energy, the difficulty in recycling it at the end of life and the production of toxic vapours during a fire.

### SUMMARY

The aim of the present disclosure is to propose an acoustic absorption and concealing device formed of a multilayer material of reduced thickness having a low reaction to fire in a vertical position and an external aesthetic textile appearance.

Another aim of the disclosure consists of the acoustic absorption device having optimal acoustic absorption, concealing and thermal reflection features.

For this purpose, the disclosure proposes an acoustic absorption and concealing device including at least one vertical strip, or a vertical panel made of a material including at least three structural layers, a central layer made of an acoustic absorbent material, and two external layers made of a knitted material having an acoustic transparency, said external layers being applied respectively on each side of the central layer. The blind of the disclosure being particular, in that:
the two external layers are made from flame-retardant polyester fibre threads;
the absorbent central layer is made of a textile material including, as a major component, polyester fibres;

and in that an assembly thickness of said three structural layers is less than 7 mm.

The acoustic absorption device of the disclosure is, for example, a blind including at least one vertical strip or a Japanese-type partition panel.

Each strip of panel of the device of the disclosure therefore includes a sandwiched structure wherein the external layers are made in a knit permeable to sound and cover an absorbent central layer aesthetically. In particular, the disclosure proposes using the same composition of fibres in the external layers and in the internal layer, and to control the acoustic properties of said layers through the structural features thereof.

On the one hand, using a knit having a great transparency to sounds as external layers, makes it possible for the central layer to easily absorb the acoustic waves in contact with the device. On the other hand, the production of external layers and the central layer from the same type of fibres, i.e. polyester, is highly advantageous as it provides the device with a low reaction to fire and optimal absorption and concealing features with a reduced strip or panel thickness.

In a preferred aspect of the disclosure, the central layer is made of polyester felt. Using felt makes it possible to obtain an optimal absorption coefficient, while ensuring a good rigidity/flexibility ratio for the acoustic absorption device. In addition, using felt also ensures thermal reflection properties for the acoustic adsorption device of the disclosure.

In preferred aspect of the disclosure, the acoustic adsorption device of the disclosure can include all or some of the following features in any technically operable combination:
The central layer is made from non-flame-retardant polyester fibres or from flame-retardant polyester fibres.
The central layer has a thickness of 0.15 to 5 mm, and the external layers have a thickness of 1 to 1.5 mm;
The central layer has a thickness of 3 mm;
The device has an absorption coefficient α_{w} of at least 0.40;
The external layers are formed of a warp or Rachel knit obtained on four bars with two ground threads feeding the first guide needle (Rachel notation) and two appearance threads feeding the second and third guide needles (II and III);
The external layers are intrinsically flame-retardant and include an external water-repellent coating;
The acoustic absorption device of the disclosure is a blind including a suspension rail including at least one fixing by mobile clipping maintaining said at least one vertical strip, and for which a deviation distance between a lower end of the suspension rail and an upper end of the at least one vertical strip is equal to or less than 5 mm. This aspect makes it possible to optimise the performances of the concealed, acoustically absorbed and thermally reflected blind.
The blind includes a fixing bar of substantially rectangular shape and including, in an upper end, a central clearing provided with open oblique walls and a clipping space situated below said central clearing. In particular, the clipping space situated in an internal area of the bar makes it possible for a top fixing of the strips of the blind.
Each vertical strip of the blind includes an upper hem wherein is inserted said fixing bar, said hem being provided with a central opening being superposed with the clipping space and the central clearing of the bar.

### BRIEF DESCRIPTION OF THE DRAWINGS

Other data, features and advantages of the present disclosure will appear upon reading the following non-limited description, in reference to the appended figures, which represent, respectively:

[FIG. 1] A schematic representation of the multilayer structure of a strip or panel of the acoustic absorption device of the disclosure.

FIG. 2] A simplified representation of a blind including a fixing rail and a plurality of vertical strips suspended to said rail according to the disclosure.

[FIG. 3] An illustration of a fixing bar according to the disclosure.

[FIG. 4] A schematic representation of the fixing bar during insertion in a strip of the blind of the disclosure.

### DETAILED DESCRIPTION

The disclosure relates to an acoustic absorption and concealing device having at least one vertical strip or a vertical panel of mainly flat surface including a sandwiched multilayer structure. The acoustic absorption device of the disclosure is an interior arrangement element, for example, a blind including a plurality of mobile vertical strips on a rail, or a blind of one single strip being wound and unwinding on a horizontal axis, or a Japanese-type partition panel determining a limitation of space or a sliding door. FIG. 1 illustrates the arrangement of layers of the acoustic absorption device 1 of the disclosure wherein two external layers 20 are applied from one side to the other of an absorbent central layer 10.

The external layers 20 are made of a knitted aerated material of which a mesh opening makes it possible to ensure a transonic character (acoustic transparency) to the material, and on the other hand, provides an aesthetic textile appearance outside of the product.

The technical problem of the present disclosure has been to select the materials of the external layers and of the absorbent central layer making it possible to product an assembly of reduced thickness, and according to the fire reaction standard for interior arrangement products arranged in a vertical position according to European (Euroclasses) classification or the French classification. Of course, the assembly of materials must also have efficient features in terms of acoustic absorption, concealing, and have an aesthetic appearance.

For this purpose, the reaction to fire of different materials has been tested following its assembly with the external layers by means of a vinyl glue. In particular, the materials have been selected for the acoustic absorbent properties thereof and the improved fire reaction classification thereof following a flame-retardant treatment. Furthermore, the following materials have been tested: polyurethane, cotton, glass, wool, viscose, polyester, meta-aramid, modacrylic.

The reaction to fire is the way in which a material behaves when it is exposed to a heat source according to a classification established by standardised tests. For example, the French Classification (Standard NF P.92.507) classifies the materials in five categories from M0 to M4, M0 being the most difficult to inflame, and M4 the easiest to inflame.

European classification (Standard EN 13501-1) classifies the materials into 6 categories from A to F and replacing the categories M0 to M4. It also considers the clearing of smoke (s1, s2, s3) and the projection of burning drops (d0, d1, d2). Table 1 below shows the equivalences between the two classifications for products other than flooring.

TABLE 1

| | |
|---|---|
| Classes according to NF EN 13501-1 | Requirement |

| | | | |
|---|---|---|---|
| A1 | — | — | Incombustible |
| A2 | s1 | d0 | M0 |
| A2 | s1 | d1 (1) | M1 |
| A2 | s2 | d0 | |
| | s3 | d1 (1) | |
| B | s1 | d0 | |
| | s2 | d1 (1) | |
| | s3 | | |
| C (3) | s1 (2) (3) | d0 | M2 |
| | s2 (3) | d1 (1) | |
| | s3 (3) | | |
| D | s1 (2) | d0 | M3 |
| | s2 | d1 (1) | M4 (non-dripping) |
| | s3 | | |

| | |
|---|---|
| All classes (2) other than E-d2 and F | M4 |

(1) The performance level d1 is accepted only for products which are not heat-meltable under the conditions of the test.
(2) The performance level s1 provides the information provided by the modified order of 4 Nov. 1975, based on regulations and using certain materials and products in establishments receiving from the public and the instruction of 1^{st} Dec. 1976 relating to it.
(3) Admissible pour M1 if not substantial in the sense of the definition of appendix 1.

It must be noted that the requirements of the legislation on Fire Safety vary according to the given use with a construction or planning product. For products arranged in a vertical position, as in the case of the device of the disclosure, the French legislation requires an M2 classification.

Table 2 shows an extract from the results of the reaction to fire of different assembly compositions tested during the development of the device of the disclosure.

TABLE 2

| | | Absorbent central | | | |
|---|---|---|---|---|---|
| | Absorbent central | layer fire | External layer | External layer fire | Assembly fire |
| No. | layer composition | classification | composition | classification | classification |
| 1 | Polyester felt | — | Flame-retardant | B-s1, d0 | C-s2, d0 |
| | | | polyester | | |
| 2 | Flame-retardant | B-s1, d0 | Flame-retardant | B-s1, d0 | C-s2, d0 |
| | polyester felt | | polyester | | |
| 3 | Flame-retardant | M1 | Flame-retardant | B-s1, d0 | C-s2, d0 |
| | polyester fabric | | polyester | | |
| | (fabric 1) | | | | |
| 4 | Flame-retardant | M1 | Flame-retardant | B-s1, d0 | C-s2, d0 |
| | polyester fabric | | polyester | | |
| | (fabric 2) | | | | |
| 5 | Non-woven flame- | M1 | Flame-retardant | B-s1, d0 | C-s2, d0 |
| | retardant | | polyester | | |
| 6 | Flame-retardant | M1 | Flame-retardant | B-s1, d0 | D-s3, d0 |
| | cotton fabric | | polyester | | |
| 7 | Flame-retardant | M1 | Flame-retardant | B-s1, d0 | E-s3, d0 |
| | polyurethane | | polyester | | |
| | (supplier 1) | | | | |
| 8 | Flame-retardant | M1 | Flame-retardant | B-s1, d0 | E-s3, d0 |
| | polyurethane | | polyester | | |
| | (supplier 2) | | | | |
| 9 | Flame-retardant | M1 | Flame-retardant | C-s3, d0 | E-s3, d0 |
| | polyurethane | | wool | | |
| | (supplier 1) | | | | |
| 10 | Flame-retardant | M1 | FR viscose and | D-s3, d0 | E-s3, d0 |
| | polyurethane | | meta-aramid | | |
| | (supplier 1) | | mixture | | |

Unexpectedly, these studies show that despite the selection of material all having at least one starting M1 classification, the assembly with the external layers modifies the reaction to fire of the materials unpredictably. In addition, certain materials have shown assembly incompatibilities being conveyed by a non-aesthetic appearance of the device (materials not shown in the table).

Following the tests carried out, the present disclosure proposes to produce the strip of the panel of the device with a material including at least three structural layers, and wherein the two external layers and the absorbent central layer are composed of polyester fibres, and in particular wherein the external layers are made from flame-retardant impregnated polyester fibre threads.

That is, that the disclosure proposes to product external layers from flame-retardant polyester fibres and the absorbent central layer in a textile material including, as a major component, in volume and in mass, non-flame-retardant or optionally flame-retardant polyester fibres. Indeed, it has been determined surprisingly that using a non-flame-retardant polyester central layer, does not significantly modify the reaction to fire of the strips of the device of the disclosure in comparison of using an absorbent central layer made of flame-retardant polyester. The flame-retardant treatment on the external layers therefore appears to be sufficient to contain the reaction to fire of the central layer when it is also composed of polyester. Of course, it is also possible to achieve the disclosure with an absorbent central layer made from flame-retardant polyester.

Table 3 below shows an example of acoustic properties, obtained with an assembly of the two external layers made from flame-retardant polyester fibres, each of a thickness of 1.2 mm, and a grammage of 330 g/m², with different absorbent central layers made from flame-retardant or non-flame-retardant polyester. The results show that using polyester in the external layers and in the central layer makes it possible to obtain blind strips or a partition panel of a thickness as low as 2.55 mm. These blinds of reduced thickness meet the requirements of French regulations in terms of behaviour to fire and have a weighted absorption coefficient α_{w} of at least 0.45. By comparison, a strip including the external layers of the disclosure assembled with a 10 mm thick, flame-retardant polyurethane foam, also has an absorption coefficient α_{w} of 0.45 with an assembly thickness of 12.4 mm.

TABLE 3

| Central layer | | | | Assembled blind | |
|---|---|---|---|---|---|
| | Thickness | Grammage | External layer | Thickness | |
| Fibre composition | (mm) | (g/m²) | Textile type | (mm) | α W |
| Non-woven | 0.3 | 200 | Flame-retardant | 2.7 | 0.45 |
| flame-retardant | | | polyester knit | | |
| polyester | | | | | |
| Flame-retardant | 0.15 | 120 | Flame-retardant | 255 | 0.45 |
| polyester fabric | | | polyester knit | | |
| (fabric 1) | | | | | |
| Flame-retardant | 0.15 | 110 | Flame-retardant | 2.55 | 0.45 |
| polyester fabric | | | polyester knit | | |
| (fabric 2) | | | | | |
| Polyester felt | 3 | 500 | Flame-retardant | 5 | 0.45 |
| | | | polyester knit | | |
| Flame-retardant | 3 | 500 | Flame-retardant | 5 | 0.45 |
| polyester felt | | | polyester knit | | |

In a preferred aspect of the disclosure, the absorbent central layer is made of non-flame-retardant polyester felt making it possible to obtain an absorption coefficient α_{w} of 0.45 and good concealing and thermal reflection properties. Preferably, a thickness of about 3 mm is selected to obtain a quality aesthetic appearance and a good flexibility/rigidity ratio. In this aspect of the disclosure, the assembly thickness is less than 7 mm, and preferably 5 mm±10%.

On the other hand, the external layers are made of an aerated fabric composed of a knit obtained on a warp or Rachel machine with four bars with two ground threads feeding the first guide needle (Rachel notation) and two appearance threads feeding the second and third guide needles (II and III) according to the assembly illustrated in table 4 below, and wherein I=guide needle number, x=mesh which does not exist, -=reverse mesh, O=weft.

TABLE 4

| I | II | III |
|---|---|---|
| x | x | x |
| ∘ | x | x |
| — | — | — |
| x | x | x |
| x | 2x | 2x |
| — | — | — |
| x | x | x |
| 2x | x | x |
| — | — | — |
| x | x | x |
| x | ∘ | ∘ |
| — | — | — |

Such a knit has an external textile appearance, an increased resistance to tearing, a good deformability and is sufficiently opaque to mask the state of the surface of the absorbent layer. In particular, it is the presence of two threads on the same guide needle which gives the knit its particular relief appearance. French patent application no. FR 2 759 386 A1 describes in detail, the aspect of said knit. In this assembly, the value x is preferably two according to the Rachel notation.

This knit structure is made from four flame-retardant polyester threads in the mass. The thread is for example, formed of two single titration threads 250 tex for a torsion comprised between 500 and 600 T/m. The fibres forming each single thread have, for example, a cross-section of 60 mm and a titration of 3.3 dtex.

The meshes of the knit obtained have a grammage of the order of 330 g/m².

Using this knit advantageously makes it possible to consider a fire reaction European classification C-s2,d0 when the external layers are assembled to the absorbent central layer made from the same type of fibres. The external layers are assembled, for example, by means of a vinyl glue.

The external layers also include an external water-repellent coating preventing marks from being absorbed or to be incrusted on the external face of the knit, thus offering an easy washing to the blind in case of dirt. In the present disclosure, the external water-repellent coating is made with a discontinuous membrane not blocking the openings of the mesh. This membrane is applied by padding and polymerising in a furnace. The membrane is, for example, formed of a polyurethane resin mixture, water-repellent resin and other additives (wetting, pH corrector, etc.).

Another aim of the disclosure is that the acoustic device has optimal acoustic absorption, concealing and thermal reflection features.

In an aspect of the disclosure, the acoustic absorption device is a blind and the disclosure proposes to install said blind 1 by means of a fixing rail 2 including a series of mobile fixings 3 in a slide, and to clip the vertical strips 4 of the blind with a deviation distance less than 10 mm, and preferably less than 5 mm between an upper end of the strips and a lower end of the rail.

The decrease of the deviation distance between the rail 2 and the strips 4 of the blind makes it possible to cover a more significant surface of the space to be concealed, and therefore to optimise the concealing, acoustic absorption and thermal reflection performances of the blind when it is installed to cover an opening.

In a preferred aspect of the disclosure, the deviation distance between an upper end of the strips 4 of the blind and a lower end of the rail 2 is 4 mm, this distance corresponding to the minimum value with which the blind conserves a mobility and an easy installation. This fixing called “top” can be obtained by means of a fixing bar including a clipping space in an internal zone of said bar.

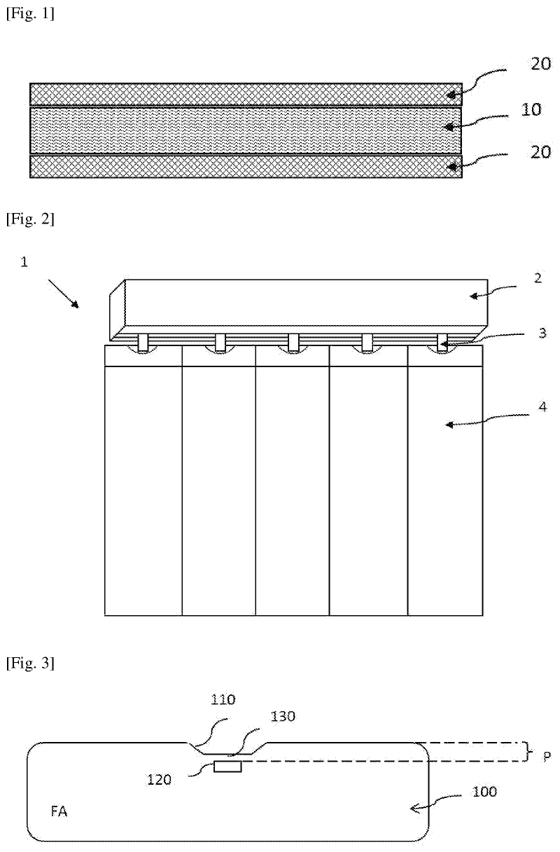

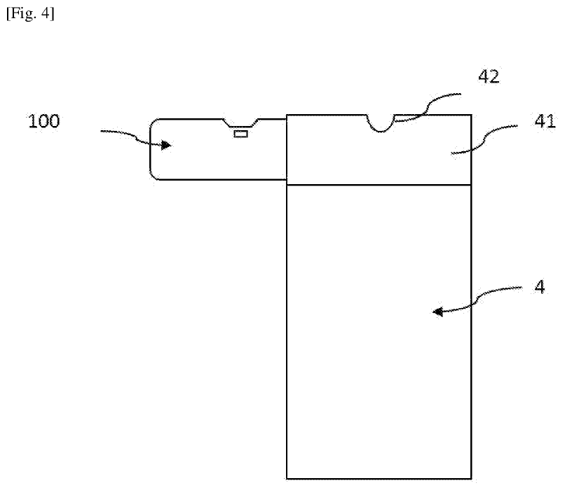

FIG. 2 illustrates an example of a preferred aspect of the disclosure of the bar 100 having a substantially rectangular and flat shape. For the effects of the description, a lower side and an upper side of the bar 100 are defined when the bar is put in a vertical position, with a front face FA and a rear face of the bar 100 positioned along a vertical axis, and with a longitudinal axis of the bar positioned along a horizontal axis. In order to make it possible for a top fixing of the blind, the upper side of the bar 100 includes the clipping space 120 in an internal zone or area of the bar. By internal cross-section, this means an area of the bar located inside the edge defined by a substantially rectangular perimeter of the bar. For example, an upper face of the clipping space 120 is situated, substantially centred, at a depth P of 4.5 mm of the bar. This depth is measured from top to bottom, and from the upper side of the bar put in a vertical position.

The bar 100 also includes, in an upper end, a central clearing 110 situated above the clipping space 120 to facilitate the clipping of the bar. This clearing includes open oblique walls and the depth thereof defines the dimensions of a suspension bar 130 formed between the upper face of the clipping space and the lower face of the clearing. For example, for a depth of the central clearing of 3 mm and of 4.5 mm for the upper face of the clipping space, a height of the suspension bar is 1.5 mm. Advantageously, this height makes it possible for a clipping compatibility of the bar with the clipping systems, which are universal for blinds. In addition, the oblique walls of the central clearing of the bar facilitate the clipping of the strips on the fixings of the suspension rail.

Preferably, the fixing bar is made of steel and of colour similar to that of the central layer.

As illustrated in FIG. 3, the fixing bar 100 is introduced in an upper hem 41 of the strips 4 of the blind. This hem also includes a central opening 42 being superposed with the clipping space 120 of the bar 100 and its central clearing 130.

The concealing performances, as well as the thermal reflection have been determined for the blind of the disclosure. In particular, the performances of a blind including a plurality of vertical strips have been compared with the performances of a solid plate. Table 5 below shows the results of these tests carried out according to the standard NF EN 410:2011 and NF EN 14500:2008. As it can be observed, there is no significant difference between the performances of the blind in the configuration thereof in vertical strips, and a plate of the same solid material.

TABLE 5

| | | Blind - solid | Blind - plurality of |
|---|---|---|---|
| Graphite colour | | plate | strips |
| Visible spectrum | Absorption | >97 | >95 |
| (380-780 nm) | Reflection | 2 | 3 |
| Light problem | Transmission | <1 | <2 |
| Solar spectrum | Absorption | >74 | >74 |
| (280-2500 nm) | Reflection | 25 | 24 |
| Thermal problem | Transmission | <1 | <2 |

The device of the disclosure is therefore very advantageous in that it makes it possible to obtain an excellent concealing to light and notable thermal reflection values for a blind. When the blind includes a plurality of strips fixed to the rail of the blind by means of the fixing bar described above, the blind makes it possible to obtain a concealing equivalent to the total coverage with the same material, while conserving the possibility of modulating this concealing and to dim the light if needed, by modifying the position of the strips of the blind. Of course, excellent concealing and thermal reflection performances are also obtained when the acoustic absorption device of the disclosure is achieved in the form of a blind with one single strip or a Japanese-type partition panel.

What claimed is:

1. An acoustic absorption and concealing device including at least one vertical strip, or a vertical panel, made of a material including at least three structural layers, a central layer made of an acoustic absorbent material, and two external layers made of a knitted material having an acoustic transparency, said external layers being applied respectively to each side of the central layer, wherein:
the two external layers are made from flame-retardant polyester fibre threads; and
the absorbent central layer is made of a textile material including as major component, polyester fibres; and
in that an assembly thickness of said three structural layers is less than 7 mm.

2. The acoustic absorption device according to claim 1, wherein the central layer is made of polyester felt.

3. The acoustic absorption device according to claim 1, wherein the central layer is made from non-flame-retardant polyester fibres or from flame-retardant polyester fibres.

4. The acoustic absorption device according to claim 1, wherein the central layer has a thickness of 0.15 to 5 mm, and the external layers each have a thickness of 1 to 1.5 mm.

5. The acoustic absorption device according to claim 1, wherein the central layer has a thickness of 3 mm.

6. The acoustic absorption device according to claim 1, wherein the external layers are formed of a warp or Rachel knit obtained on four bars with two ground threads feeding the first guide needle (Rachel notation) and two appearance threads feeding the second and third guide needles (II and III).

7. The acoustic absorption device according to claim 1, wherein the external layers are intrinsically flame-retardant and include an external water-repellent coating.

8. The acoustic absorption device according to claim 1, wherein the acoustic absorption device is a blind including at least one vertical strip, a suspension rail including at least one fixing by mobile clipping maintaining said at least one vertical strip, and for which a deviation distance between a lower end of the suspension rail and an upper end of the at least one vertical strip is ≤5 mm, and preferably 4 mm.

9. The acoustic absorption device according to claim 8, wherein the blind includes a fixing bar of substantially rectangular shape and including, in an upper end, a central clearing provided with open oblique walls and a clipping space situated below said central clearing.

10. The acoustic absorption device according to claim 9, wherein the at least one vertical strip includes an upper hem wherein is inserted said fixing bar, said hem being provided with a central opening being superposed with the clipping space and the central clearing of the bar.

11. The acoustic absorption device according to claim 9, wherein the clipping space is situated at a depth P of the bar determining a deviation distance of 4 mm between the lower end of the fixing rail and the upper end of the vertical strip when said strip is suspended to the rail.
